(19) United States
(12) Patent Application Publication
(10) Pub. No.: US 2008/0181578 A1
(43) Pub. Date: Jul. 31, 2008

(54) TRANSCODING OF MEDIA CONTENT

(76) Inventor: David H. Hanes, Loveland, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/669,232

(22) Filed: Jan. 31, 2007

(51) Int. Cl. H04N 7/01

(52) U.S. Cl. 386/124

(57) ABSTRACT

A method comprises digitally recording media content to a first format compatible with a first playback device. The method then comprises transcoding the media content from the first format to a second format compatible with a second playback device based on at least one user-provided attribute of the second playback device, or based on a format automatically determined to be supported by the second playback device.

### BACKGROUND

Users have a choice of a variety of media content playback devices comprising televisions as well as portable devices such as cellular telephones and other types of portable audio, video and audio/video players. However, downloading and converting the media content into a format suitable for each of these disparate playback devices unfortunately is cumbersome.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows a storage device usable in the system of FIG. 1; and

FIG. 3 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

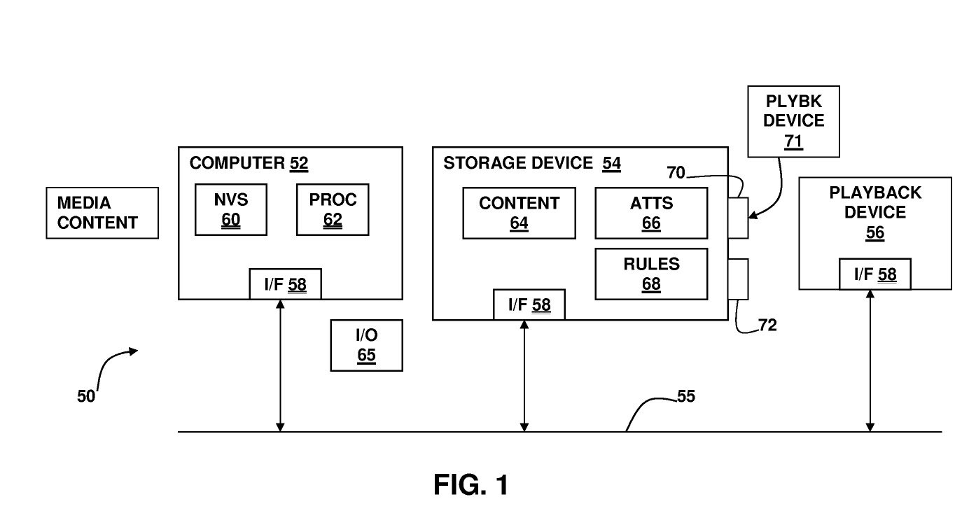

FIG. 1 illustrates a system 50 provided in accordance with various embodiments. As shown, system 50 comprises a computer 52, a storage device 54, and a playback device 56 coupled together via a network 55. The network 55 can be a wired network (e.g., Ethernet) or a wireless network. Each of the computer 52, storage device 54, and playback device 56 comprises a network interface 58 which couples the respective device to the network and thus to the other devices. In some embodiments, the storage device 54 is referred to as a network attached storage (NAS) device.

The computer 52 comprises at least a processor 62 coupled to non-volatile storage. Non-volatile storage 60 comprises, for example, a hard disk drive. The non-volatile storage 60 also comprises software that is executed by the processor 62 to provide the computer with some or all of the functionality described herein as being attributed to the computer. One or more input/output (I/O) devices 65 is also provided for a user to control the computer 52. Examples of such I/O devices comprise one or more of a keyboard, a mouse, a trackball, and a display. In some embodiments, the computer 52 comprises a personal computer while in other embodiments, the computer 52 comprises a special purpose device such as a personal video recorder (PVR), a digital video recorder (DVR), etc. Thus, while the term “computer” is used in this disclosure with regard to device 52, the term “computer” is intended to be used in a broad sense to encompass all such devices.

The computer 52 can record media content and, via the network 55, save the media content on the storage device 54 for subsequent playback on the playback device 56. The playback device 56 may comprise, for example, a television monitor. In at least some embodiments, the media content comprises a live cable or television broadcast, a podcast or other type of Internet-provided content, or media content from a compact disk read only memory (CD ROM) or digital video disk (DVD).

In some embodiments, the computer 52 records the media content by temporarily storing the media content in the computer's non-volatile storage 60. As will be explained below, the user of the computer 52 has control over which media content is to be recorded. The computer 52 then transfers the recorded media content across the network 55 to the storage device 54 for storage therein. In at least some embodiments, the media content is saved in a format suitable for playback on the playback device 56. Such a format may comprise any one of a variety of compression techniques. For example, the media content may be saved in an MPEG-1 format for playback on the playback device 56. Other illustrative formats comprise MPEG-2, MPEG-4, H.264, VC-1, and DivX. Via, for example, a remote control usable with the playback device 56, the user can cause the storage device 54 to play on the playback device 56 media content stored on the storage device 54. The playback process comprises decompression of the media content to the extent the media content being played back was stored in a compressed format.

Referring still to FIG. 1, the storage device 54 comprises one or more playback device interfaces 70 and 72. Each of such interfaces can be used to connect, for example, a portable playback device (e.g., playback device 71) to the storage device. The interfaces 70, 72 may be wired or wireless interfaces. The playback devices comprise, for example, media content-enabled cellular telephones, MP3 devices, and the like. A user of such a playback device 71 connects the device to the appropriate interface 70, 72 on the storage device 54. The storage device 54 transfers media content to the connected playback device for subsequent playback thereon.

In at least some embodiments, a playback device (e.g., playback device 71) that connects to an interface 70, 72 of the storage device 54 stores media content in a format that is different from the media content format used to store files for playback on playback device 56. Suitable formats for use with regard to playback devices 71 that connect to interfaces 70, 72 comprise, for example, Moving Picture Exports Group (MPEG)-1, MPEG-2, MPEG-4, H.264, and divx. While playback device 56, for example, is compatible with MPEG-2 file formats, playback device 71 may be compatible with MPEG-4 file formats.

The storage device 54 thus transcodes media content from one file format compatible with the playback device 56 to one or more file formats compatible with whatever playback devices 71 the user may opt to use. Transcoding media content comprises, in at least some embodiments, decompressing the content to an uncompressed form and then recompressing the content in accordance with a different compression technique. Once media content is transcoded, multiple copies of the media content are stored on the storage device—the multiple copies differ in the applicable format (e.g., different compression techniques).

In some embodiments, the transcoding of the media content occurs in a background mode, but could occur in “real-time,” that is, at the time the file is to be downloaded to the playback device. If the transcoding occurs in a background mode, the storage device 54 provides an announcement on the storage device (e.g., illuminates a light emitting diode) or sends a signal to the computer that the transcoding is complete. By performing the transcoding in a background, the processing of the storage device 54 need not be as high as would be needed to perform real-time transcoding. Alternatively stated, a lower power storage device (low in terms of speed) can adequately transcode media content in a background mode and then provide the transcoded content upon completion.

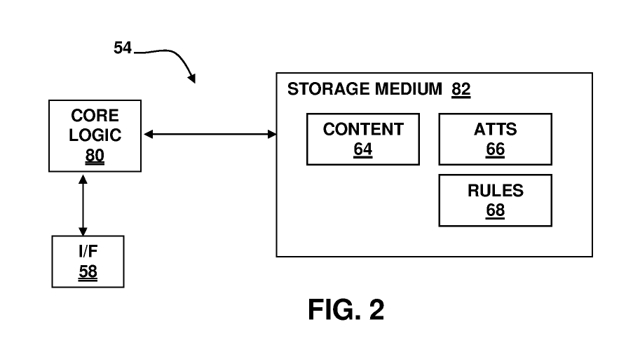

FIG. 2 shows a block diagram of the storage device 54. As shown, the storage device 54 comprises core logic 80 coupled to the network interface 58 and a storage medium 82. The storage medium comprises non-volatile storage such as a hard disk drive. The storage medium stores content 64 as provided to the storage device 54 by the computer 52.

The storage medium 82 also comprises playback device attributes 66 and rules 68 (see also FIG. 1). A user can register a playback device 71 with the storage device 54. In accordance with various embodiments, via the I/O device 65, the user provides one or more attributes of a playback device to the computer 52, which then stores the attributes on the storage device 54. For a given playback device, the attributes comprise any one or more of memory capacity, display resolution, processor type, processor speed, supported file type, and combinations thereof. Multiple playback devices can be registered in this fashion, with the storage device 54 thus storing a set of attributes for each of multiple playback devices. When transcoding media content into a format suitable for a playback device, the storage device selects a target media content format based on the attributes for the intended playback device. For example, portable playback devices such as cellular telephones have smaller displays than television monitors as used in a home environment. The resolution of a portable playback device may be different (e.g., less) than the resolution of a full-size television monitor. Accordingly, the file format for media content to be played back on a small portable playback device should be different than the file format used for a full-size television monitor.

The storage device 54 also comprises rules 68 which are entered by the user through the computer 52, which then stores the rules on the storage device 54. Along with the attributes, the rules are used by the storage device 54 to initiate transcoding of selected media content to a target format. The user-provided rules enable the user to define when and how the media is to be automatically transcoded. For example, the user might specify in the rules that particular television broadcasts are to be recorded and stored in a particular folder on the storage device 54. The user may register a particular cellular telephone with the storage device 54 as noted above. Further, the user may specify in the rules that whenever a new television broadcast is recorded into the specified folder, that the storage device 54 should automatically begin transcoding that content into a format suitable for the specified cellular telephone using the attributes provided to the storage device 54 when the phone was registered.

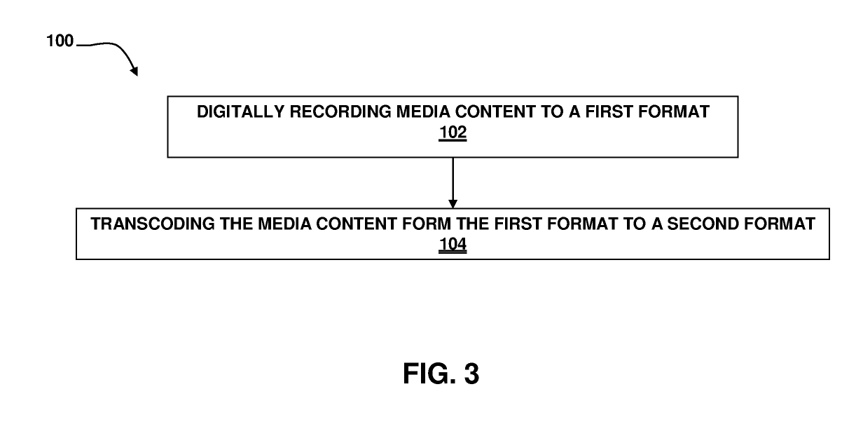

FIG. 3 illustrates a method 100 in accordance with various embodiments. At 102, method 100 comprises digitally recording media content to a first format. The first format may be a format compatible with the playback device 56. The method 100 also comprises transcoding the media content from the first format to a second format. The second format may be a format compatible with another playback device. The storage device 54 performs the transcoding process and selects the second format based on at least one user-provided attribute of the second playback device. The storage device 54 may select the second format based also on one or more of the user-provided rules. The act of transcoding the media content may be performed in a background mode.

In some embodiments, the storage device 54 selects the second format for the transcoding process based, at least in part, by examining a connected playback device 71. For example, the user connects a playback device 71 to the storage device 54. The storage device 54 detects the playback device 71 and determines the video formats supported by the playback device 71. In some embodiments, this determination is made by accessing a look-up table within the storage device 54 or by accessing an on-line (e.g., Internet) source of such information over network 55. The storage device 54 would then automatically (i.e., without user input) select an appropriate format for the playback device 71 and perform the transcoding process accordingly. To the extent multiple video formats are supported by the playback device 71, the user can setup a rule that causes the storage device 54 to select one.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
digitally recording media content to a first format compatible with a first playback device;
transcoding said media content from said first format to a second format compatible with a second playback device based on at least one user-provided attribute of said second playback device or based on a format automatically determined to be supported by the second playback device.

2. The method of claim 1 further comprising transcoding said media content in a background mode.

3. The method of claim 1 further comprising registering said second playback device with a storage device containing said media content.

4. The method of claim 1 further comprising a user providing said at least one attribute of said second playback.

5. The method of claim 1 further comprising providing said at least one attribute from a group consisting of memory capacity, display resolution, processor type, processor speed, supported file type, and combinations thereof.

6. The method of claim 1 wherein transcoding said media content from said first format to a second format comprises transcoding said media content based on a plurality of user-provided attributes of said second playback device.

7. The method of claim 1 further comprising the user providing a rule that initiates said transcoding of said media content.

8. The method of claim 1 further comprising storing said media content in said second format in a second playback device.

9. The method of claim 1 further comprising storing said media content in said second format in said second playback device, said second playback device being a portable playback device.

10. The method of claim 1 wherein transcoding said media content from said first format to said second format comprising changing a compression technique.

11. A system, comprising:
core logic; and
storage coupled to said storage logic;
wherein said core logic transcodes media content from a first format to a second format in accordance with a user-specified rule or in accordance with information automatically obtained from a playback device.

12. The system of claim 11 wherein said core logic transcodes the media content from the first format to the second format also in accordance with a user-specified attribute of the playback device.

13. The system of claim 12 wherein said user-specified attribute comprises an attribute selected from a group consisting of memory capacity, display resolution, processor type, processor speed, supported file type, and combinations thereof.

14. The system of claim 11 wherein said core logic selects the second format from among a plurality of formats stored on said storage.

15. The system of claim 14 wherein said core logic selects said second format based on said user-specified rule.

16. The system of claim 11 wherein said core logic transcodes said media content from the first format to the second format in a background mode.

17. A system, comprising:
a computer;
a storage device coupled to said computer;
wherein, via said computer, a user registers a playback device with the storage device, and said storage device transcodes media content to a file format compatible with said playback device based on information provided by said user when registering said playback device.

18. The system of claim 17 wherein said storage device transcodes said media content in a background mode.

19. The system of claim 17 wherein, via said computer, the user provides a rule to said computer that causes the storage device to transcode said media content in accordance with said rule.

20. The system of claim 17 wherein said storage device an interface for said playback device.
